(19) United States
(12) Patent Application Publication
(10) Pub. No.: US 2026/0365162 A1
(43) Pub. Date: Nov. 19, 2026

(54) METHOD AND SYSTEM OF REDUCING OR AVOIDING UNDESIRED FORWARD CONTACT EVENT LOADS ON A VEHICLE WITH AN ACTIVE SUSPENSION

(71) Applicant: GM GLOBAL TECHNOLOGY OPERATIONS LLC, Detroit, MI (US)

(72) Inventors: Devon Hall, Ann Arbor, MI (US); Brian K. Saylor, South Lyon, MI (US)

(73) Assignee: GM GLOBAL TECHNOLOGY OPERATIONS LLC, Detroit, MI (US)

(21) Appl. No.: 19/208,420

(22) Filed: May 14, 2025

(51) Int. Cl. B60W 30/09; B60G 17/016; B60G 17/0195; B60W 10/18; B60W 10/22

(52) U.S. Cl. CPC B60W 30/09; B60G 17/016; B60G 17/0195; B60W 10/18; B60W 10/22; B60G 2400/823; B60G 2500/10; B60G 2500/20; B60G 2500/32; B60W 2520/06; B60W 2520/10; B60W 2520/105; B60W 2530/20; B60W 2552/50; B60W 2554/4041; B60W 2710/18; B60W 2710/22

(57) ABSTRACT

A method includes automatically monitoring a path in front of a vehicle to detect a barrier up ahead of the vehicle. The vehicle has multiple wheels to propel the vehicle and active suspensions. Each active suspension includes an actuator arranged to selectively apply a force to affect motion between at least one of the wheels and a chassis of the vehicle. The force is applied independently of passive mechanical reaction to the motion. In response to detecting the barrier, the method includes determining at least one active suspension command to change a condition of at least one of the active suspensions and determined to at least one of: avoid contact between the vehicle and the barrier, reduce an amount of contact between the vehicle and the barrier, or change a location on the vehicle that will contact the barrier. The method includes executing the active suspension command.

### INTRODUCTION

The technical field generally relates to vehicles and, more specifically, to vehicles with active suspensions used to reduce or avoid impact loads from undesired forward contact events where the vehicle is trending toward contact with an external object.

Many vehicles have structures and systems to completely avoid contact (or reduce contact) with external objects. When contact cannot be avoided, many vehicles also have systems and structures to manage contact loads such as to control longitudinal compression of components at the vehicle frame and engine compartment. Such contact avoidance and better control of contact loads occurs when the vehicle has better handling or more precise control by a driver.

Accordingly, it is desirable to provide systems and structures that attempt to avoid contact with the external object or better control of contact loads by increasing the handling performance of the vehicle. Furthermore, other desirable features and characteristics of the present disclosure will become apparent from the subsequent detailed description and the appended claims, taken in conjunction with the accompanying drawings and the foregoing introduction.

### BRIEF SUMMARY

In an example implementation, a method includes automatically monitoring, by at least one processor, a path in front of a vehicle to detect a barrier up ahead of the vehicle along the path and external to the vehicle. The monitoring includes determining a distance or time or both for the vehicle to reach the barrier. The vehicle has multiple wheels to propel the vehicle and active suspensions operably coupled to the wheels. Each active suspension includes an actuator arranged to selectively apply a force to affect motion between at least one of the wheels and a chassis of the vehicle. The force is applied independently of passive mechanical reaction to the motion. In response to detecting the barrier, the method includes determining, by at least one processor, at least one active suspension command to change a condition of at least one of the active suspensions and determined to at least one of: avoid contact between the vehicle and the barrier, reduce an amount of contact between the vehicle and the barrier, or change a location on the vehicle that will contact the barrier. The method includes executing, by at least one processor, the active suspension command to change the condition of the at least one active suspension while the vehicle is traveling forward toward the barrier or avoiding the barrier.

According to another example implementation, the method includes determining, by at least one processor, all of: whether or not an undesired contact event between the vehicle and the barrier is avoidable including determining whether the vehicle can (1) swerve to the left or right of the barrier and (2) stop directly behind the barrier without contacting the barrier, and whether or not the undesired contact event is unavoidable, and when unavoidable, changing a height of a front end of the vehicle to be closer to a height of the barrier.

According to another example implementation, the active suspension command includes instructions to control the actuator to change the height of a front end of the vehicle to be closer to a height of the barrier, in response to a determination that the undesired contact event is unavoidable.

According to another example implementation, the active suspension command directs at least one actuator of one of the active suspensions near a front of the vehicle to raise the front end of the vehicle.

According to another example implementation, the method includes providing braking active suspension commands that control one or more of the actuators to enhance brake performance operations to slow or stop the vehicle or control a deceleration rate of the vehicle as long as the braking active suspension commands do not counter-affect the active suspension command to change the height of the front end of the vehicle.

According to another example implementation, the method includes determining whether or not a steering direction change will allow the vehicle to avoid the undesired contact event.

According to another example implementation, the method includes automatically determining, by at least one processor, active suspension commands to execute a swerve to avoid the barrier including factoring at least one real-time factor of: vehicle speed, tire friction, and longitudinal acceleration of the vehicle.

According to another example implementation, the method includes automatically determining, by at least one processor, active suspension commands that change a spring force, a jounce damping force, a rebound force, or a roll stiffness to implement a swerve to avoid the barrier.

According to another example implementation, each wheel has one of the active suspensions, and the active suspension command of at least one of the active suspensions of one of the wheels is different than the active suspension command of at least one of the other active suspensions to implement the swerve.

According to another example implementation, the method includes setting, by at least one processor, the active suspension commands to implement a swerve to a right of the barrier, to be: increase a left front spring force, increase a left front jounce damping force, increase a right front rebound damping force, increase a left rear jounce damping force, increase a right rear rebound damping force, and increase a roll stiffness.

According to another example implementation, the method includes setting, by at least one processor, the active suspension commands to implement a swerve to a left of the barrier, to be: increase a right front spring force, increase a right front jounce damping force, increase a left front rebound damping force, increase a right rear jounce damping force, increase a left rear rebound damping force, and increase a roll stiffness

In another example implementation, a system includes a vehicle having a body on a chassis, wheels to propel the vehicle, and at least one active suspension operably coupling the chassis to the wheels. Each active suspension includes an actuator arranged to selectively apply a force to affect motion between at least one of the wheels and the chassis of the vehicle. The force is applied independently of passive mechanical reaction to the motion. The system has memory and processor circuitry forming one or more processors being communicatively coupled to the memory and the active suspension, the processor to operate by: automatically monitoring a path in front of the vehicle to detect a barrier up ahead of the vehicle along the path and external to the vehicle. The monitoring incudes determining a distance or time or both for the vehicle to reach the barrier, and the processor to operate by, in response to detecting the barrier, determining at least one active suspension command to change a condition of at least one of the active suspensions to at least one of: avoid contact between the vehicle and the barrier, reduce an amount of contact between the vehicle and the barrier, or change a location on the vehicle that will contact the barrier. The processor to operate by executing the active suspension command to change the condition of the at least one active suspension while the vehicle is traveling forward toward the barrier or avoiding the barrier.

Also in accordance with another example implementation, the processor is arranged to operate by determining whether the contact between the vehicle and the barrier is unavoidable including comparing a closing speed the vehicle travels toward the barrier to a speed threshold and the distance between the vehicle and the barrier and a distance threshold.

Also in accordance with another example implementation, the speed and distance thresholds are a first set of thresholds, and the processor operates by determining whether the contact between the vehicle and the barrier is avoidable by stopping or turning the vehicle in time to avoid the barrier with a second set of the thresholds that are larger than the first set of thresholds.

In another example implementation, a vehicle includes a body on a chassis, wheels to propel the vehicle, and at least one active suspension operably coupling the chassis to the wheels. Each active suspension includes an actuator arranged to selectively apply a force to affect motion between at least one of the wheels and the chassis of the vehicle. The force is applied independently of passive mechanical reaction to the motion. The vehicle has one or more controllers including memory, and processor circuitry forming one or more processors communicatively coupled to the memory. The processor is arranged to operate by: automatically monitoring a path in front of the vehicle to detect a barrier up ahead of the vehicle along the path and external to the vehicle. The monitoring includes determining a distance or time or both for the vehicle to reach the barrier. The processor is arranged to operate by, in response to detecting the barrier, determining at least one active suspension command to change a condition of at least one of the active suspensions to at least one of: avoid contact between the vehicle and the barrier, reduce an amount of contact between the vehicle and the barrier, or change a location on the vehicle that will contact the barrier, and executing the active suspension command to change the condition of the at least one active suspension while the vehicle is traveling forward toward the barrier or avoiding the barrier.

According to another example implementation, the processor is arranged to determine whether the vehicle should turn to avoid the barrier or stay straight and stop to avoid the barrier.

According to another example implementation, the processor is arranged to operate by factoring speed, tire friction, and longitudinal acceleration to determine a geometry of turns to be performed by the vehicle to avoid the barrier.

According to another example implementation, in response to determining the vehicle should turn or stop to avoid contact with the barrier while the vehicle is moving toward the barrier, the processor is arranged to operate by setting a torque on a roll stiffness actuator of the active suspension to reduce vehicle roll on the vehicle during a turn of the vehicle.

According to another example implementation, the processor is to operate by determining a difference between an expected yaw of the vehicle during a turn and a measured yaw of the vehicle during the turn, and modifying one or more roll shifting active suspension actuators to change a tire lateral load transfer distribution (TLLTD) to reduce the difference.

According to another example implementation, the processor is arranged to operate by detecting a steering wheel angle gradation, and when no gradation is detected, executing commands to increase roll stiffness, shift a tire lateral load transfer distribution (TLLTD), and increase damping on at least one active suspension actuator to be applied before a subsequent evasive turn to avoid the barrier is executed.

### BRIEF DESCRIPTION OF THE DRAWINGS

The present disclosure will hereinafter be described in conjunction with the following figures. The figures are not to scale and numerals in the figures denote like elements, and where:

FIG. 1 is a schematic diagram of an example vehicle with an active suspension system according to at least one of the implementations herein;

FIG. 2 is a schematic diagram of an example active suspension system of FIG. 1 and according to at least one of the implementations herein;

FIG. 3 is a schematic diagram of an example active suspension control system on a vehicle according to at least one of the implementations herein;

FIG. 4 is an example flow chart of a method of avoiding or reducing contact loads on a vehicle with an active suspension according to at least one of the implementations herein;

FIGS. 5A-5B is an example detailed flow chart of a method of avoiding or reducing contact loads on a vehicle with an active suspension according to at least one of the implementations herein;

FIG. 6 is a schematic diagram of a side of a vehicle showing an underride brake-dive condition of the vehicle according to at least one of the implementations herein;

FIG. 7 is a schematic diagram of a side of a vehicle showing an example underride reduction condition of the vehicle according to at least one of the implementations herein; and

FIG. 8 is a schematic diagram of a rear view of a vehicle swerving to avoid an undesired frontal contact event according to at least one of the implementations herein.

### DETAILED DESCRIPTION

The following detailed description merely presents example implementations and is not intended to limit the disclosure or the application and uses thereof. Furthermore, no intention exists to be bound by any theory presented in the preceding background or the following detailed description.

Herein, the terms ‘coupled’ and ‘connected’ are used interchangeably to refer to the relationship between objects and include direct contact between objects as well as connection through intervening objects.

Also herein, the terms ‘vertical’, ‘horizontal’, ‘up’, ‘down’, ‘higher’, and ‘lower’ are relative to each other on the vehicle and not necessarily relative to the ground unless context clearly indicates otherwise. Also, the term ‘substantially’refers to within 5% of a specified amount.

The present system and method includes automatically adjusting active suspensions on the vehicle to increase handling performance when the system detects an upcoming barrier in a path of a vehicle and that contact the barrier in an undesired contact event unless the vehicle is operated to avoid the contact. Otherwise, the vehicle may be controlled to reduce the amount of contact or the location of the contact on the vehicle to better control contact forces experienced by the vehicle. Thus, the system and method include at least one mode when the contact is unavoidable and another mode when the contact can be avoided. The term barrier herein is meant broadly to refer to any object in the path of the vehicle and that can be contacted by the vehicle, such as moving barriers such as a back of a truck or stationary barriers such as a guard rail. A contact ‘avoidance’ mode generates active suspension commands that control an active suspension on the vehicle to either (1) provide better control and handling so that it is easier for a driver (or autonomous driving) to turn and swerve out of the way of the oncoming frontal barrier or at least reduce the amount of contact, or (2) to entirely avoid frontal contact by controlling the active suspension to make it easier to brake and stop the vehicle within a distance to avoid contact with the frontal barrier.

In a second contact ‘unavoidable’ mode, the disclosed system and method may control the active suspension to raise the front of the vehicle (or keep the vehicle at a more horizontal pitch) that places the bumper or the front end of the vehicle closer to a height of the barrier to avoid or reduce underride (also referred to as brake dive). Underride contact loads are experienced by some vehicles when a vehicle contacts another barrier in front of the vehicle, such as a back of a truck, a guard rail, and so forth. In these cases, the forward momentum and heavy braking force may shift weight of the vehicle forward which moves the front of the vehicle downward, thereby permitting more of the vehicle to fit under the barrier. In these cases, the contact loads often are managed solely by body structure of the vehicle, and particularly by transmitting longitudinal loads from the upper-front of the vehicle and onto the engine compartment components. This can result in the bumper and front of the vehicle being substantially useless in absorbing some of the load from the contact or impact with the barrier such that the loads may not be directly transferred to the chassis of the vehicle and vertical center (or crumble zone) of the engine where the loads are better absorbed. Instead, the underride can cause more undesired longitudinal compression at an upper side of the engine compartment, where the absorption of the longitudinal forces may be less and risk of the forces entering past the A pillar and firewall of the vehicle may be greater.

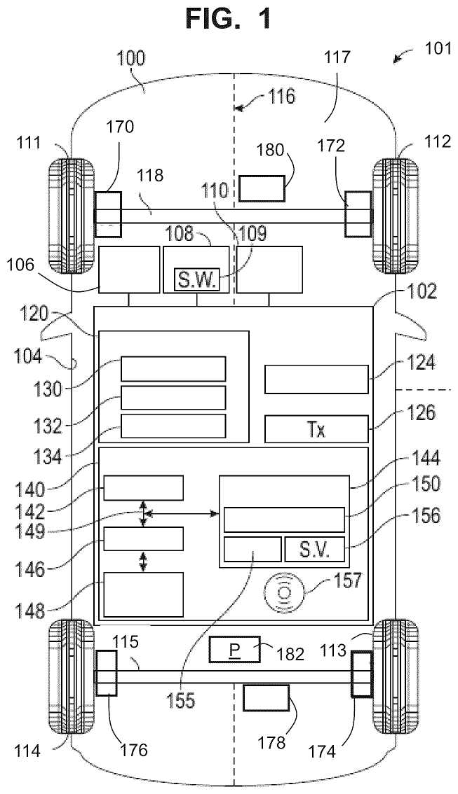

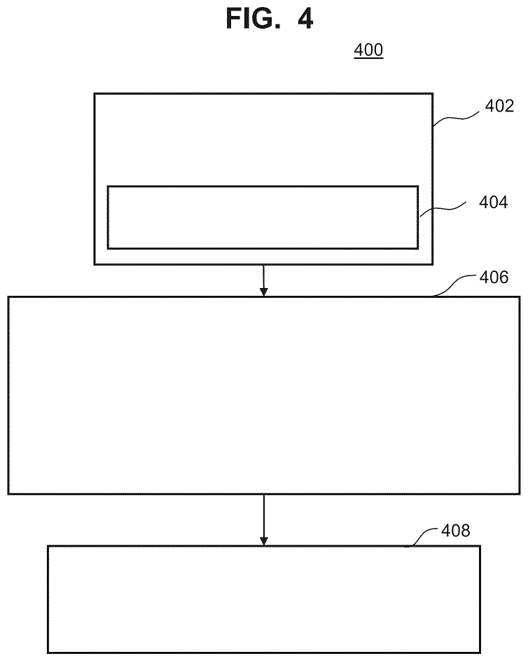

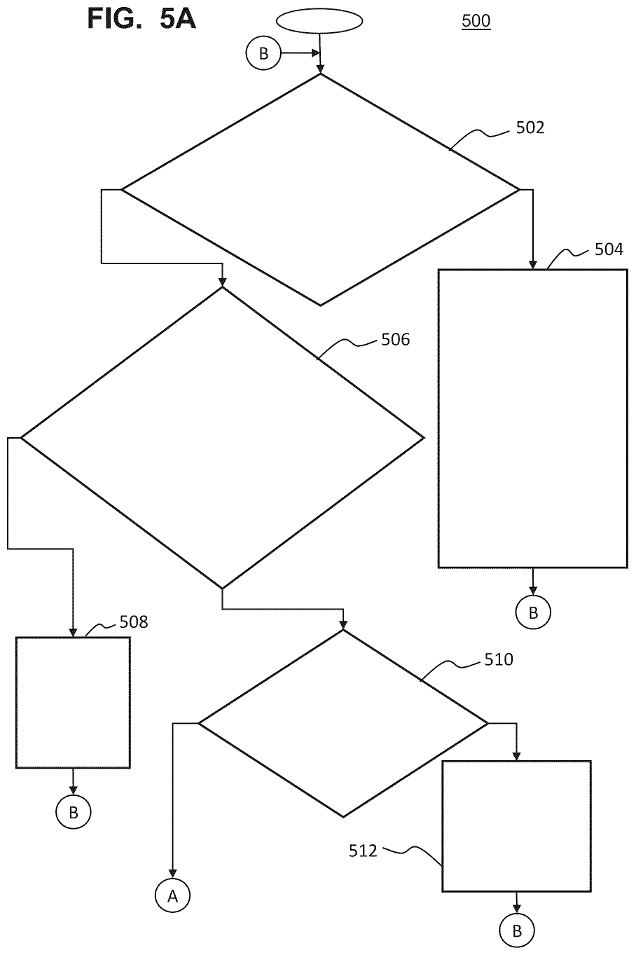

Referring to FIG. 1, a system 101 includes one or more vehicles 100 with an active suspension system to avoid or reduce impact or contact loads experienced from an undesired contact event with a frontal barrier. In various implementations, the system 101 may perform these tasks in accordance with an example process 400 (FIGS. 4) and/or 500 (FIGS. 5A-5B), in accordance with example implementations described herein.

Specifically, as described in greater detail further below, in various implementations, the vehicle 100 has a controller 140 (or computer system) with processor circuitry that forms at least one processor 142 and a memory 144 that stores programs 150 including software and/or firmware that performs avoiding or reducing contact loads on a vehicle with an active suspension as described in detail below.

By one example form, the vehicle 100 is an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain implementations such as trucks with more than four wheels, and so forth. In certain implementations, the vehicle 100 may also comprise any other motorized vehicle with active suspensions and cameras and/or sensors that can at least detect an upcoming barrier.

In some implementations, the vehicle 100 may be operated in whole or in part by a human driver, or alternatively may comprise an autonomous or semi-autonomous vehicle, for example in which vehicle control (including acceleration, deceleration, braking, and/or steering) is automatically planned and executed by a control system 102 of the vehicle 100, in whole or in part. In addition, the vehicle 100 may be operated by a human at certain times and via automated control at other times. Thus, the vehicle 100 includes one or more functions that may be controlled automatically via the control system 102 to provide driver assistance features.

Also, the example vehicle 100 includes a body 104 that is arranged on a chassis 117 and has a longitudinal central axis 116. The body 104 substantially encloses other components of the vehicle 100. The body 104 and the chassis 117 may jointly form a frame. For clarity, assume the vehicle 100 is shown as a see-through diagram in FIG. 1 looking through a top of the vehicle. Thus, the vehicle 100 also includes a plurality of wheels including a front left wheel 111, a front right wheel 112, a rear right wheel 113, and a rear left wheel 114. The wheels 111-114 are each rotationally coupled to the chassis 117 near a respective corner of the body 104 to facilitate movement of the vehicle 100.

By one form, each wheel 111-114 may have an active suspension 170, 172, 174, and 176 respectively that attenuate impact loads from the wheels and that can be used to control the amount of handling provided by the vehicle. Handling herein refers to the precision a vehicle moves when a driver (or autonomous system) steers, accelerates, and/or brakes. Thus, as one example, the active suspensions 170, 172, 174, and 176 may be controlled to increase traction, and in turn, handling may be increased. Other active suspensions may be present instead or in addition to the active suspensions 170, 172, 174, and 176. These include a rear roll stiffness (or sway) active suspension 178 for the rear wheels 113-114, and a front roll stiffness (or sway) active suspension 180 in the front of the vehicle 100 for front wheels 111-112. One or more power supplies 182 may provide power to all of the active suspensions.

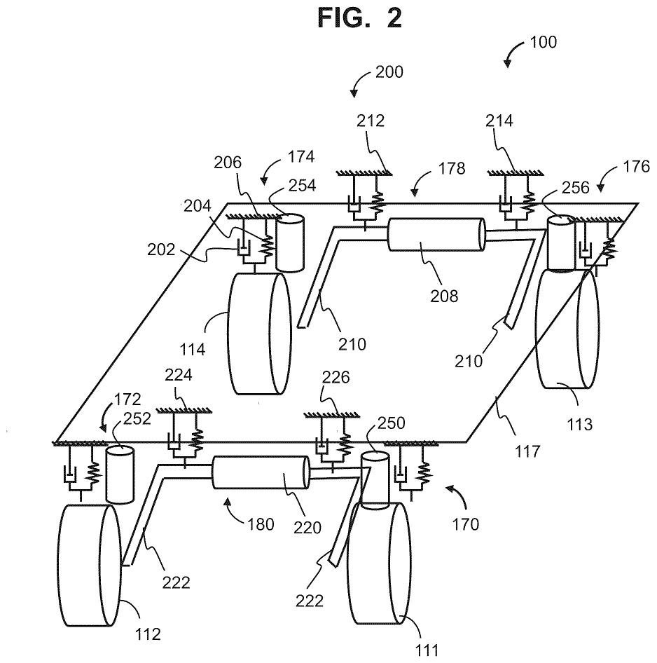

Referring to FIG. 2 for more detail, an active suspension system 200 of vehicle 100 is shown with the active suspensions 170, 172, 174, 176, 178, and 180. Herein, for an active suspension, the term active refers to a suspension that adds force or energy to the system and is a powered component with a power source. An active suspension has an actuator arranged to selectively apply a force or energy to affect motion between at least one of the wheels and a chassis (or body) of the vehicle while the force is applied independently of passive mechanical reaction (or compliance) to the motion. This is in contrast to springs and shock absorbers that merely react to the forces from the wheel, and is in contrast to adaptive suspensions such as magnetorheological fluid suspensions that stiffen when electromagnets are energized in reaction to the motion of the wheel and in a vicinity of the magnetorheological fluid. Thus, it will be understood here that the motion includes motion from independent forces (versus the forces from passive reaction) that press a tire toward the ground or a road so that friction and traction is increased between the tire and the ground or road.

Each active suspension 170, 172, 174, 176, 178, and 180 respectively have an active suspension actuator 250, 252, 254, 256, 208, and 220 that replaces, or effectively operates as, a damper (or shock absorber) 202 and/or a spring 204 of a traditional suspension that is directly or indirectly fixed to the chassis 117 by an anchor assembly 206. For the sway (or roll stiffness) active suspensions 178 and 180, the actuators 208 and 220 are operably and respectively connected to torsion or sway bars 210 and 222 that in turn connect to suspension arms (not shown) of each wheel 111-114 to change the roll stiffness of the body 104 and chassis 117 relative to the wheels 111-114. Thus, the roll stiffness actuator 208 has sway bar bushings 212 and 214 with one at each torsion bar 210 that connect the sway bars to the body and allow it to twist as necessary during suspension movement. Similarly, the roll stiffness actuator 220 operates with sway bar bushings 224 and 226 one at each torsion or sway bar 222.

As mentioned, the active suspension system 200 may only have the wheel active suspensions 170, 172, 174, and 176, only sway active suspensions 178 and 180, or both. When the vehicle 100 only has the wheel active suspensions 170, 172, 174, and 176, those wheel active suspensions 170, 172, 174, and 176 also may have sufficient strength to effectively act as roll stiffness (or sway) actuators, thereby eliminating the need for the sway active suspensions 178 and 180 (then merely using the sway active suspensions 178 and 180 as a secondary system only to be used in certain circumstances). Active suspension actuators may be electromechanical actuators (such as a ball screw actuator), an electromagnetic system or system with electromagnetic linear actuators, an electrohydraulic system, and/or hydraulic actuators (such as those in fully active hydropneumatic systems). For roll stiffness, the actuators additionally may be hydraulically actuated torsion bars, electromechanical actuators integrated into sway bars (such as electric torque motors), and so forth.

Returning for now to FIG. 1, the power supply 182 for the active suspensions may be one or more high-power, fast-response electrical and/or hydraulic power supplies capable of delivering significant energy to actuators in real time. By one example form for electromechanical active suspensions, the power supply 182 may provide about 50-800V depending on the actuator being used. For a hydraulic active suspension, a high-pressure hydraulic supply (often exceeding 200 bar) may be supported by an electrically driven hydraulic pump or central hydraulic unit with accumulators. Otherwise, the relevant control and operation of the active suspension system 200 is described in detail below with processes 400 and 500.

A drive system 110 is mounted on the chassis 117, and drives the wheels 111-114, for example via front and rear axles 118 and 115, respectively. The drive system 110 preferably comprises a propulsion system. In certain example implementations, the drive system 110 comprises an internal combustion engine and/or an electric motor/generator, coupled with a transmission thereof. In certain implementations, the drive system 110 may vary, and/or two or more drive systems 110 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

By some forms, the vehicle 100 also includes a braking system 106 and a steering system 108 in various implementations. In example implementations, the braking system 106 controls braking of the vehicle 100 using braking components that are controlled via inputs provided by a driver (e.g., via a braking pedal in certain implementations) and/or automatically via the control system 102. Also in example implementations, the steering system 108 controls steering of the vehicle 100 via steering components (e.g., a steering wheel 109 that is part of a steering column coupled to the front axle 118 and/or the front wheels 111-112) that are controlled via inputs provided by a driver (e.g., via the steering wheel 109 in certain implementations) and/or automatically via the control system 102.

By one approach, the control system 102 is coupled to the braking system 106, the steering system 108, and the drive system 110. In various implementations, the control system 102 at least facilitates the generating and processing of sensor data on camera images or detected by other sensors for the vehicle 100 and/or for other vehicles. In addition, in certain implementations in which the vehicle 100 is an autonomous or semi-autonomous vehicle, the control system 102 also provides in certain circumstances control over automated features of the vehicle 100 (including automated operation of the braking system 106, the steering system 108, and/or the drive system 110), including using one or more models that are trained using the sensor data.

As depicted in FIG. 1, in various implementations, the control system 102 includes a sensor array 120, a display 124, a transceiver 126, and the controller 140. By one example, the sensor array 120 obtains sensor data for generating current or real-time vehicle context data. In various implementations, the sensor array 120 includes one or more cameras 130 (such as video cameras and/or still image cameras). Also in some examples, the sensor array 120 may also include one or more other detection sensors 132 (e.g., radar, sonar, light detection and ranging (LIDAR), infrared, or the like) and/or other sensors 134 (e.g., vehicle position sensors, speed sensors, accelerometers, gyroscopes, inertial sensors (e.g., inertial measurement unit (IMU)), braking sensors, steering sensors, suspension sensors, and so on). Suspension sensors used herein may be suspension height sensors, active suspension actuator sensors, or rotary position sensors, which indicate a status of the active suspensions 170, 172, 174, 176, 178, and 180.

In various implementations, the vehicle cameras 130 used to obtain images of the sensor data of the road may include front, rear, side, and/or surround-view cameras including wide angle, 360 degree, and/or fish-eye lens cameras, as well as monocular, stereo, infrared, time-of-flight, thermal, LIDAR cameras, and so forth. These cameras 130 may capture images that are then processed by object detection algorithms that may be used to detect and measure a roadway (also referred to herein as a road or path) on which the vehicle 100 is operating and is able to detect shape and size (e.g., dimensions) of road surfaces and barriers on the road (such as other vehicles), as well as other objects. Such imaging systems also may measure or compute distances from the vehicle 100 to the barriers, and/or a duration from a current time point to a time to contact with the barrier. In various implementations, video camera images are obtained. Additionally or alternatively, still camera images may be obtained.

By some examples, images captured by the cameras 130 and other sensor data from the other sensors 134 are analyzed by one or more processors 142 to perform object detection and recognition algorithms such as those based on any one or more algorithms of: machine learning, neural networks, Convolutional Neural Networks (CNNs), Region-Based Convolutional Neural Networks (R-CNN), Recurrent Neural Networks (RNNs), Mask R-CNNs, You Only Look Once (YOLO), Single Shot MultiBox Detector (SSD), Semantic Segmentation such as Fully Convolutional Networks (FCNs) and U-Nets, for example, Haar Cascades (Viola-Jones (VJ) Detector), Histogram of Oriented Gradients (HOG), MOG (Mixture of Gaussians) background subtraction, Scale-Invariant Feature Transform (SIFT), Speeded-Up Robust Features (SURF), template matching, DPM (Deformable Parts Model), GMM (Gaussian Mixture Model) background subtraction, LDA (Linear Discriminant Analysis), and/or many others.

In various implementations, the detection sensors 132 and/or other sensors 134 obtain additional information as to the roadway and/or the operation of the vehicle 100 itself (e.g., position, speed, deceleration and/or acceleration thereof, and so on) for use in operating the vehicle 100, for example either in accordance with autonomous operation of the vehicle 100 and/or of certain components thereof, or particularly here to control active suspension settings to increase vehicle handling in certain conditions described herein. This may include radar sensors, ultrasonic, and other types of sensors as well as inertial measurement units (IMUs) that can detect the motion and orientation of a vehicle, such as a pitch angle forward and back and roll angle from side to side. The IMU may be used in conjunction with suspension measurements and can be used in addition to, or alternatively to, a camera-based system to detect a frontal barrier upcoming ahead on a path of the vehicle.

By one example form, and rather than using cameras 130 alone to detect objects, and particularly the shape of a road (including curbs and so forth), the cameras 130 are used as part of an advanced driver assistance system or unit (ADAS), a front collision alert (FCA), or similar system that uses both optics and the other detection sensors 132 and other sensors 134 to detect barriers up ahead along a path of a vehicle and to monitor the current (or real-time) context of the vehicle, at the vehicle, and near the vehicle. Thus for example, data collected from camera images, radar, LiDAR, and ultrasonic sensors can be used together to detect the frontal barrier and whether or not the vehicle can avoid undesired contact with the barrier or reduce contact with the barrier. This may include performing sensor fusion and machine learning or neural network models that receive input from a variety of sensors rather than image data alone, as well as other techniques.

In the present example, the vehicle 100 also includes a transceiver 126 to communicate with remote systems, servers, devices, modules, or units. Thus, any one or more parts or components (or units) of the control system 102 and/or controller 140 that performs processing for any of the operations described herein related to avoiding or reducing impact loads from a frontal barrier can be performed remotely when desired. Specifically, in various implementations, the controller 140 (and, in certain implementations, the control system 102 itself) is disposed within the body 104 of the vehicle 100. In one implementation, the control system 102 is mounted on the chassis 117. In certain implementations, the controller 140 and/or control system 102 and/or one or more components thereof may be disposed outside the body 104, for example on a remote server, in the cloud, or other device where image processing is performed remotely. It will be appreciated that the control system 102 and/or the controller 140 may otherwise differ from the implementation depicted in FIG. 1. For example, the controller 140 may be coupled to, or may otherwise utilize, one or more remote computer systems and/or other control systems, for example as part of one or more of the above-identified vehicle 100 devices and systems.

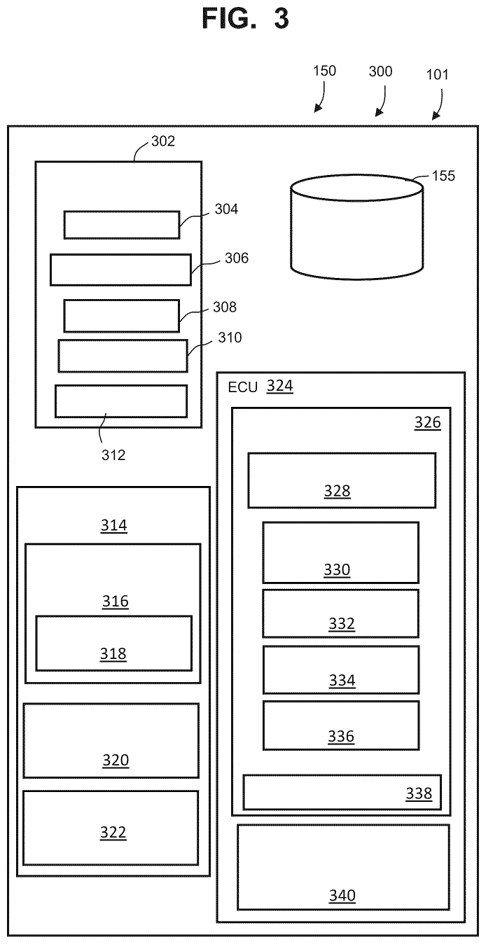

Also, the control system 102 may have a display on the vehicle 100 that can provide messages to occupants of the vehicle 100, such as alerts when a frontal barrier is detected and/or when the load impact (or contact) avoidance or reduction system (FIG. 3) automatically controls the active suspension system 200 to avoid or reduce contact loads from the frontal barrier. The display 124 may be any that can provide a screen for an occupant or user in the vehicle to see the images on the display 124. Such a display may be a digital display, a graphical user interface (GUI), an LED display, a plasma display, an LCD display, an organic light emitting diode (OLED) display, a thin-film transistor (TFT) display, heads up display (HUD), 3D displays, holographic displays, virtual or augmented displays, and so forth.

In various implementations, the controller 140 is coupled to the sensor array 120, as well as to the braking system 106, the steering system 108, the drive system 110, and the active suspension system 200. In various implementations, the controller 140 is also coupled to the display 124 and the transceiver 126.

In various implementations, the controller 140 comprises, or is, a computer system, and includes the processor 142, the memory 144, an interface 146, a storage device 148, and a computer bus 149. In various implementations, the controller (or computer system) 140 obtains sensor data from the sensor array 120, and in certain implementations additional data via the transceiver 126. In various implementations, the controller 140 processes the observational data, including images of a roadway up ahead on an expected path of the vehicle 100. In certain implementations, the controller 140 also uses the sensor data for developing, training, and/or implementing one or more autonomous driving models for the vehicle 100 (e.g., for automated control of the braking system 106, steering system 108, drive system 110, and/or active suspension system 200). In various implementations, the controller 140 provides these and other functions in accordance with the operations of the processes and implementations depicted in FIGS. 4-5B and as described further below in connection therewith.

In the depicted implementation, the controller 140 (or computer system) includes the processor 142 to perform the computation and control functions of the controller 140, and may comprise circuitry or circuits that form any type of processor or multiple processors, single integrated circuits such as a microprocessor, or any suitable number of integrated circuit devices and/or circuit boards working in cooperation to accomplish the functions of a processing unit. This may include a System on a chip (SoC) and one or more processor cores. During operation, the processor 142 executes one or more programs 150 contained within the memory 144 and, as such, controls the general operation of the controller 140 and the computer system of the controller 140, generally in executing the processes described herein, such as the processes and implementations depicted in FIGS. 2-8 and as described further below in connection therewith. By one form, the program 150 includes or is an impact (or contact) avoidance or reduction system for detected frontal barriers 300 as explained below with FIG. 3.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted implementation, the memory 144 stores the above-referenced program 150 along with one or more databases 155 that may hold data pertaining to determining active suspension commands to control the active suspensions 170-180. To increase vehicle handling to avoid or reduce contact with a detected frontal barrier. As one example, the memory 144 also may store thresholds to determine whether the frontal barrier can be avoided and stored in the database 155 as described further below.

The bus 149 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one implementation, the interface 146 obtains the various data from the sensor array 120 and/or the navigation system 122. The interface 146 can include one or more network interfaces to communicate with other systems or components.

The storage device 148 can be any suitable type of storage apparatus, including various different types of direct access storage and/or other memory devices. In one example implementation, the storage device 148 comprises a program product from which memory 144 can receive the program 150 that executes one or more implementations of the processes and implementations of FIG. 3 and as described further below in connection therewith. In another example implementation, the program product may be directly stored in and/or otherwise accessed by the memory 144 and/or a secondary storage device (e.g., disk 157), such as that referenced below.

The bus 149 can be any suitable physical or logical means of connecting computer systems and components. This includes, but is not limited to, direct hard-wired connections, fiber optics, infrared and wireless bus technologies. During operation, the program 150 is stored in the memory 144 and executed by the processor 142.

It will be appreciated that while this example implementation is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to conduct the distribution. Examples of signal bearing media include recordable media such as floppy disks, hard drives, memory cards and optical disks, and transmission media such as digital and analog communication links. It will be appreciated that cloud-based storage and/or other techniques may also be utilized in certain implementations. It will similarly be appreciated that the computer system of the controller 140 may also otherwise differ from the implementation depicted in FIG. 1, for example in that the computer system of the controller 140 may be coupled to or may otherwise utilize one or more remote computer systems and/or other control systems.

Referring to FIG. 3, the program 150 may be or have a frontal barrier impact load (or contact) avoidance or reduction system 300 that has units (also referred to as modules or components) that may be formed of any combination of software and/or firmware operated by processors 142, which in turn are formed by hardware processor circuitry. The hardware processor circuitry may be shared hardware such as with a central processing unit (CPU), digital signal processor (DSP), and so forth. Otherwise, the hardware may have dedicated or specific function processors may be provided that operate neural networks and other structures for image processing for example, such as with graphical processing units (GPUs) or image signal processors (ISPs).

In the present example, the impact load avoidance or reduction system 300 detects frontal barriers, determines whether the barrier can be avoided, and depending on the situation determined by detection of the barrier, the impact load avoidance or reduction system 300 determines and executes the active suspension commands to control the active suspension system 200 and avoid or reduce the impact with the frontal barrier.

The frontal barrier detection may be performed by using a vehicle context barrier monitoring unit 302 that has at least a speed unit 304, a distance to barrier unit 306, an acceleration unit 308, and by one option, an FCA unit 310 and/or the ADAS 312. The FCA unit 310 may use sensors such as a front-facing camera, radar, or both, to monitor closing distance between the vehicle 100 and the frontal barrier while using other sensors to monitor the closing speed. If the system detects the frontal barrier is being approached too fast and contact is likely, the FCA unit 310 may issue an alert to the driver by using visual and/or audible warnings. The FCA unit 310 can detect open road in front of the vehicle 100 and including open space left or right of the frontal barrier that has sufficient clearance for the vehicle 100 to swerve into and avoid contacting the frontal barrier. The sensor data and/or computed parameters from the vehicle context barrier monitoring unit 302 may be provided to a contact event monitor unit 314. The ADAS 312 may be separate or part of the vehicle context barrier monitoring unit 302, or the vehicle context barrier monitoring unit 302 may be part of the ADAS 312, FCA 310, or other monitoring unit or system of system 300 or other program 150. The ADAS 312 also may provide sensor data or parameters to the contact event monitor unit 314.

The contact event monitor unit 314 may have a contact event avoidance detection unit 316 to determine if contact with the frontal barrier can be avoided. This may include a steering direction unit 318 to determine whether it is possible to steer or swerve around the frontal barrier and which direction to turn. If not immediately clear from the position of the vehicle or other factors, a steering wheel angle gradient unit 320 determines if a driver is beginning to turn one way or another in order to select which way to swerve around the frontal barrier, and a zero gradient turn unit 322 is provided to set roll stiffness and balance Tire Lateral Load Transfer Distribution (TLLTD) to provide better handling of the vehicle 100 as well.

In one example form, an electronic control unit (ECU) 324 may generate and execute the active suspension commands among other tasks for other systems known to be managed by the ECU 324. Here, the ECU 324 may have a suspension control unit 326 with an anti-dive suspension unit 328 that uses the active suspension to control the pitch and underride (or brake-dive) of the vehicle. A forward brake avoidance unit 330 uses the active suspension to assist longitudinal braking to stop the vehicle before contact with the frontal barrier. A swerve avoidance unit 332 generates suspension swerve commands such as by adjusting spring force, and jounce or rebound of active suspension actuators. A roll stiffness unit 334 generates roll-stiffness suspension commands to control roll stiffness, while an under/over steer unit 336 balances TLLTD. A braking performance unit 338 provides active suspension commands to enhance braking, whether the distance to stop or slow, or a rate of deceleration, and in turn to reduce an amount of contact or avoid the barrier whether the barrier is found to be avoidable or unavoidable. An active suspension command control 340 receives active suspension command signals from the suspension control unit 326 and may generate the active suspension command signals. The active suspension command control 340 then controls and coordinates the transmission of the commands to the active suspensions 170, 721, 174, 176, 178, and/or 180 to have the commands executed at the active suspensions. The details of the operation of these units is described below with processes 400 and 500.

Referring to FIG. 4, a process 400 of avoiding or reducing impact (or contact) loads from undesired contact between a vehicle and a frontal barrier is provided according to at least one of the implementations described herein. The process 400 is described with operations 402-408 generally numbered evenly. The systems, vehicles, devices, and components of FIGS. 1-3 and 5A-8 may be referred to where relevant.

As a preliminary matter, the process 400 may operate the frontal barrier impact load avoidance or reduction system 300 (FIG. 3) to control the active suspension system 200 (FIG. 2). By one form, the systems 200 and 300 are both automatically activated as soon as the vehicle 100 is turned on or may be in always-on states. Otherwise, the active suspension system 200 is activated with power on of the vehicle while the driver manually activates the system 300 by engaging an activator such as a physical switch or button in the vehicle or virtual activator on a graphical user interface (GUI) on a display in the vehicle.

Process 400 may include “automatically monitor a path in front of a vehicle to detect a barrier up ahead of the vehicle along the path and external to the vehicle” 402. Thus by one example form, and upon activation, the system 300 may immediately receive monitoring data to detect and react to frontal barriers on a road or path in front of the vehicle. Alternatively, the activation and/or receiving of monitoring data may be received in response to additional triggers such as the detection of the frontal barrier.

So for example, when immediate monitoring is to be performed, the monitoring can begin while the vehicle is not moving. Otherwise, the monitoring may be set to start only when the vehicle is in motion. In this case, the monitoring may begin when any motion is detected from the vehicle's sensors, or may be set to begin when the vehicle reaches a minimum rate, such as 5 MPH.

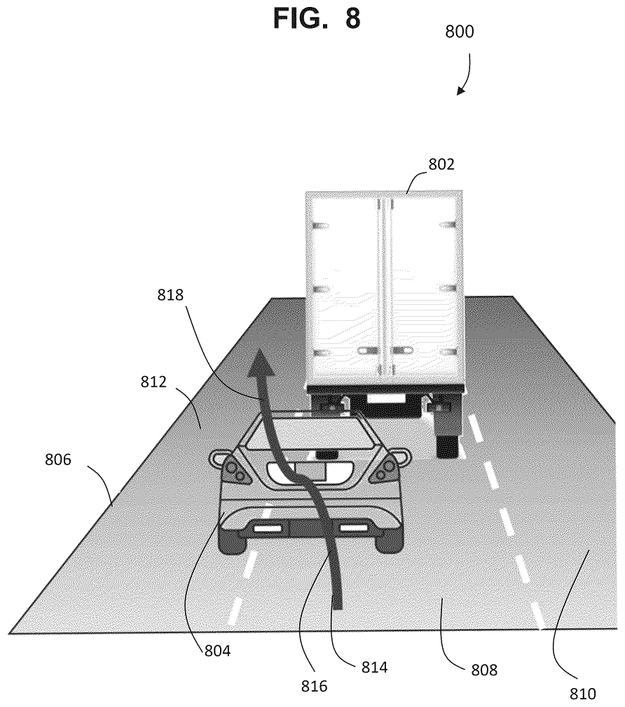

By one form, the monitoring by the vehicle context barrier monitoring unit 302 specifically for frontal barriers and contact avoidance automatically occurs when, and by one form only when, the vehicle is already traveling along a road or path, and the vehicle context barrier monitoring unit 302 detects an upcoming frontal barrier, such as a back of a truck (see FIG. 8 for example). By other forms, the sensors and systems may be used to detect the location of the vehicle so that the process 400 can only be used in certain locations, such as on highways and expressways, or roadways with relatively high speed limits for example. Alternatively, no such limit may be imposed and the process 400 can be implemented no matter the current speed of the vehicle or location or motion of the vehicle. The monitoring may occur at short sample intervals such as 10 to 100 milliseconds to provide data in real-time.

Operation 402 may include “determine a distance or time or both for the vehicle to reach the barrier” 404. Where the sensor data from the vehicle cameras, IMUs, and other sensors may be provided to the vehicle context barrier monitoring units to obtain or compute at least two of: (a) the current distance to the detected frontal barrier, (b) closing speed (and indirectly time to contact) the frontal barrier, and (c) acceleration of the vehicle toward the frontal barrier by the corresponding units of the vehicle context barrier monitoring unit 302. Other parameters may be determined from the sensor data such as whether the vehicle is in a turn to the right or left and/or the steering wheel has a gradation indicating the driver may be about to turn the vehicle.

Process 400 may include “in response to detecting the upcoming barrier, determining at least one active suspension command to change a condition of at least one of the active suspensions to at least one of: avoid contact between the vehicle and the barrier, reduce an amount of contact between the vehicle and the barrier, or change the location of the vehicle that will contact the barrier” 406. An overview of these processes are as follows while process 500 below provides an example detailed procedure for deciding among available avoidance and contact reduction options.

Once the sensor data and/or parameters are obtained, the contact event monitor unit 314 may use the obtained parameters to determine whether or not contact with the frontal barrier is avoidable or unavoidable. This may include use of the distance, speed, and/or acceleration as well as the parameter data indicating whether the vehicle is moving straight toward the frontal barrier or is attempting to turn or swerve to avoid the frontal barrier.

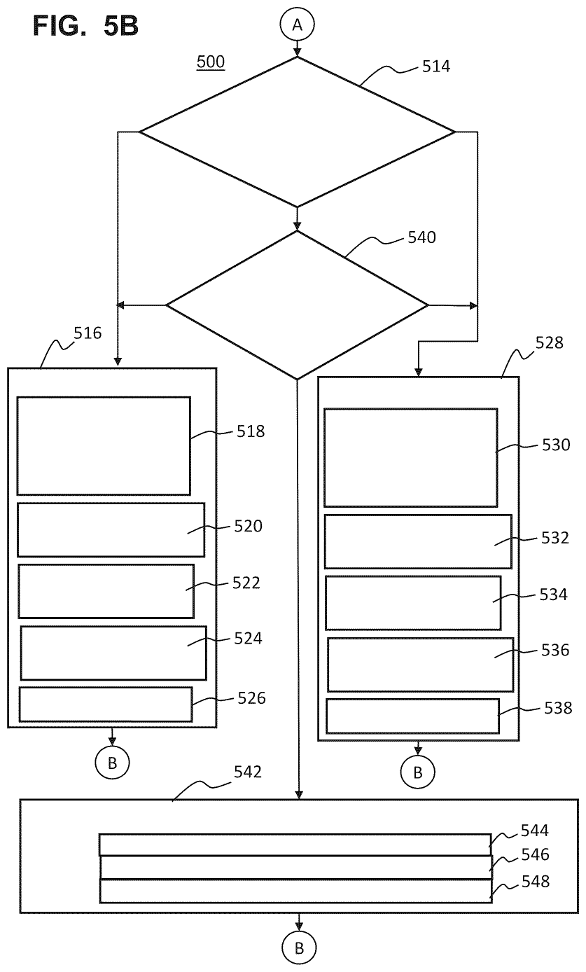

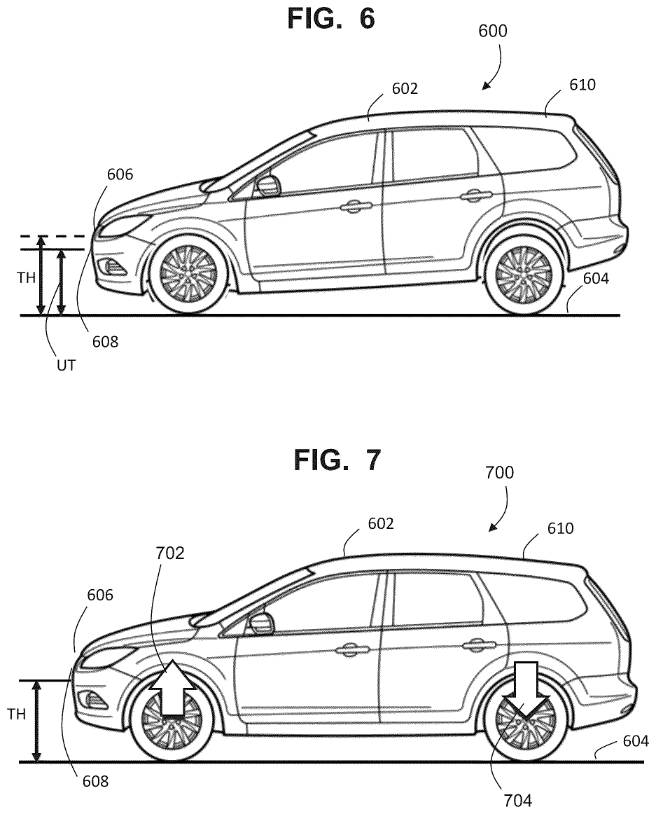

The ECU 324 then determines the appropriate active suspension commands in light of the current motion of the vehicle and the positions (or context) of the vehicle and frontal barrier. When it is found that contact with the barrier is unavoidable, the ECU 324 may provide active suspension commands to raise the front of the vehicle (as an anti-underride or anti-brake dive technique as shown with FIGS. 6-7) to better place the front bumper or front of the vehicle at a better height to absorb or transmit more of the contact forces in a controlled manner according to the intentional structure of the vehicle and to attempt to prevent or reduce contact forces from transmitting past the A pillar and firewall of the vehicle. This also may include setting the active suspensions to aid with anti-underride brake mechanisms. Otherwise, when it is determined that the contact is avoidable, the ECU 324 may determine whether the vehicle can simply be stopped or significantly slowed before contacting the barrier, and if so, generates active suspension commands to enhance the braking to a stop or slowing. When it is determined that the vehicle still has distance (and time) to turn or swerve out of the way of the frontal barrier (see FIG. 8), the ECU 324 determines which direction to turn. With any of these maneuvers, the ECU 324 may adjust roll stiffness, pitch stiffness, and TLLTD (Tire Lateral Load Transfer Distribution) as needed to provide better handling of the vehicle for the driver or ADAS.

Whenever an active suspension command is to be issued, either the ECU maneuver-specific unit 328-336 may generate the active suspension command or the active suspension command control 340 may generate the commands. In either case by this example form, the active suspension command control 340 then transmits the commands to the appropriate active suspension 170, 172, 174, 176, 178, and/or 180 (FIG. 2). These commands may be provided as the monitoring occurs in real-time.

Process 400 may include “execute the active suspension command to change a condition of the at least one active suspension while the vehicle is traveling forward toward the barrier or avoiding the barrier” 408. The process 400 thereby improves vehicle handling characteristics (or in other words, the precision of the reaction to the driving of the vehicle) for the upcoming steering avoidance event thereby reducing the amount of contact with the barrier and/or providing better control of the contact forces absorbed or transmitted through the vehicle if not completely avoided.

Referring to FIGS. 5A-5B for more detail, a process 500 of avoiding or reducing impact loads from undesired contact between a vehicle and a frontal barrier is provided according to at least one of the implementations described herein. The process 500 is described with operations 502-548 generally numbered evenly. The systems, vehicles, devices, and components of FIGS. 1-4 and 6-8 may be referred to where relevant.

Process 500 may include the inquiry “closing speed to external object >S-threshold, and distance to object <D1-threshold? (i.e., is a contact event going to happen?)?” 502, and this contact avoidance detection or testing may be performed by the contact event monitor unit 314. This first test determines whether the frontal barrier is avoidable at all. Thus, this test determines whether the vehicle will contact the frontal barrier no matter what action is taken on the vehicle. To determine the speed and distance thresholds S-threshold and D1-threshold to evaluate whether a vehicle is capable of avoiding contact with a frontal barrier positioned ahead, either by stopping or by executing an evasive maneuver such as swerving for example, various testing methodologies may be employed. These may include controlled field tests using vehicles instrumented with sensors as mentioned above to measure vehicle speed, acceleration, deceleration, and steering angle in real time. Test scenarios may vary vehicle approach speeds, road surface conditions (e.g., dry, wet, low-friction), and frontal barrier distances to determine threshold conditions under which the vehicle can successfully stop or change trajectory to avoid contact. In addition to empirical testing, computational modeling and simulation of vehicle dynamics may be used to evaluate stopping distances, turning radii, and time-to-contact metrics under different operating conditions, including variations in vehicle mass, braking system efficiency, and driver reaction times. The collected data may be used to establish the speed and distance thresholds that define intervention criteria for active suspension commands. Such testing, data, and thresholds may be already available from the ADAS 312 and/or other autonomous driving systems.

When the contact is unavoidable, process 500 then may include “in priority order: raise or lower suspension for increased contact event performance, 2) Set anti-dive for best braking performance without compromising contact event performance” 504, and this may be performed by the anti-dive suspension unit 328 and/or the braking performance unit 338 as described below with process 500.

Referring to FIGS. 6-7 for example, a brake dive (or underride) situation 600 is shown. Specifically, a vehicle 602 on a road 604 is in a brake dive or underride situation 600 where the brakes are applied causing the vehicle 602 to shift its weight forward and in turn causing the vehicle 602 to pitch forward where a front 606 and front bumper 608 of the vehicle 602 is lowered relative to the ground 604 and rear 610 of the vehicle 602. In this underride situation 600 as mentioned above, longitudinal forces from contact with a frontal barrier will cause those forces to contact the vehicle 602 at a target height TH rather than an actual brake dive, underride height UH that is the current height of the front bumper 608 in an underride situation. This causes the contact forces to be absorbed or transmitted through the upper side or non-ideal height of the crumple zone, here being the engine bay.

By implementation of the anti-underride control of the active suspensions, the system 300 actively re-levels the vehicle to bring the front bumper closer to or at a better height for contact with the frontal barrier. This may include raising the front 606 of the vehicle 602 while the vehicle is heavily braking and decelerating. By some alternative forms, the system 300 may lower the front 606 of the vehicle 602 such as when the vehicle 602 is a much larger and taller vehicle (e.g., a high SUV) than the vehicle ahead (such as a very short sports car) forming the frontal barrier, thereby improving vehicle contact performance. Even when the system 300 cannot identify an improved front or front bumper height, the system 300 may adjust the height of the front bumper to remain closer to a factory height.

The anti-dive suspension unit 328 may use the FCA 310 and the inertial measurement units (IMUs) to determine longitudinal acceleration, vehicle speed, and pitch rate to identify the dive when contact is imminent. Tire friction also may be an estimate based on previous historical driving data for the vehicle and may be used to measure the height or amount of the dive.

Referring to FIG. 7, once identified, the anti-dive suspension unit 328 may issue active suspension commands to increase spring force and adjust the jounce and rebound of the dampers in the front of the vehicle 602 to increase the height of the front 606 of the vehicle 602. Thus, the active suspension commands result in pushing the front 606 of the vehicle 602 back up while it is still under deceleration. As shown, the vehicle 602 is in an anti-underride situation 700, where the active suspensions have been controlled to raise the front 606 as with arrow 702 and lower the rear 610 as with arrow 704 so that the front bumper 608 is moved upward back to a target height TH. By one example, the vehicle 602 may be lifted up with five kilonewtons of force. By another option, the anti-dive suspension unit 328 also may issue signals to pull the rear 610 of the vehicle 602 downward with 3 kilonewtons of force to try to balance the vehicle (or make the vehicle more horizontal or level).

In addition, the braking performance unit 338 may enhance braking by providing active suspension commands to control the actuators to improve braking distance or deceleration rate. For example, the vehicle handling may be increased so that the vehicle can stop faster with anti-lock braking for example, and without fish-tailing. This may be performed as long as the braking enhancement suspension control does not counter-affect (or counteract) the anti-underride suspension commands. The process then loops back to maintain monitoring for any changing conditions.

When the contact is avoidable with evasive vehicle action, process 500 may include the inquiry “closing speed to external object >higher HS-threshold?, and distance to object <D2-threshold? (i.e., is a contact event possible but avoidable?)?” 506. Where different higher thresholds are provided that indicate whether there is still time/distance for the vehicle to avoid the contact with avoidance maneuvers. The determination of the higher thresholds is as explained for operation 502 above.

If the contact avoidance still is not possible, then process 500 may include “maintain normal suspension operation” 508 where here it is determined that the active suspension control will not change the situation of the vehicle in time to reduce the contact forces.

Otherwise, process 500 may include the further inquiry “will a steering direction change allow the vehicle to avoid the contact event?” 510. In this case, and when contact is likely but avoidable, the ADAS 312 uses sensor data to estimate which steering or braking changes can be used to avoid or minimize the contact. Referring to FIG. 8, this may include detecting an open path or clearance around the frontal barrier such as when no other vehicles are to the sides of a truck 802 up ahead forming the frontal barrier in front of the vehicle 804. The roadway 806 has three lanes where lane 808 is the current lane of the vehicle 804 and between a right lane 810, and a left lane 812, both of which are empty and open for the vehicle 804 to enter. The steering direction unit 318 then may obtain the ADAS estimation data and determine if the ADAS has estimated whether or not a swerve will avoid or reduce the contact.

When is it estimated the vehicle can be stopped in time to avoid or reduce contact, and while a swerve will not avoid or reduce the contact, process 500 may include “setup for braking: set anti-dive for best braking performance” 512. In this case, the anti-dive suspension unit 328 may provide signals or active suspension commands to raise the front of the vehicle while the forward brake avoidance unit 330 implements whatever other active suspension commands should be used to improve the handling of the vehicle and braking to a stop before contacting the vehicle.

Thus, based on this estimate, the forward brake avoidance unit 330 may change the strut forces of the active suspensions such as the roll stiffness, jounce, rebound, and/or spring force) to increase vehicle performance for the upcoming maneuver, here being a stop. Thus, for example, roll stiffness may be increased to avoid the vehicle from oversteering even for just stopping the vehicle to avoid the contact.

When it is estimated that a swerve can avoid the contact, process 500 may include the inquiry “which steering direction allows the vehicle to avoid the contact event?”514, and such a left turn swerve 814 is shown by the thick arrow (FIG. 8). Here too, the swerve avoidance unit 332 may receive swerve estimate data or estimates from the ADAS 312 or other unit or system, which indicates which way the swerve should be. This may factor which side lane 810 or 812 is clear of other objects or vehicles, which side lane 810 or 812 the vehicle is closer to, whether the driver has already started a turn, and so forth.

Process 500 may include “setup for left turn” 516. This refers to a swerve with an entry turn as indicated (either left or right) and then when needed, an exit turn of the opposite direction to straighten out the vehicle in the roadway lanes. Thus, the left swerve turn 814 may have a left entry turn 816 to the left and an exit turn 818 back to the right so that the swerve includes an ‘S’ shaped path.

The geometry of each arc of the entry and exit turns 816 and 818 of the swerve or turn 814 also may be determined by the ADAS 312, the swerve avoidance unit 332, or other unit, and may factor current distance to the barrier, closing speed, tire friction (and road surface condition), longitudinal acceleration, maximum lateral acceleration (Max Lat G) capability for the type of vehicle and specific vehicle when historical data is available. For the tire friction, the coefficient of tire friction may be scaled or interpolated as needed.

Once these swerve factors or parameters are obtained, the swerve avoidance unit 332 may determine the active suspension commands to be used to increase the handling of the vehicle during the turns or swerves. By one form, an example control algorithm may determine appropriate adjustments to one or more suspension parameters or strut forces, including spring force (or spring rate), damping characteristics (rebound and jounce, or damping rate), and roll stiffness. In some implementations, rule-based logic may be employed, where predetermined thresholds or conditions trigger specific suspension responses. In other implementations, the active suspension commands may be predetermined and placed on a lookup table (LUT) on database 155, for example, and may be used as needed to coordinate combinations of input values with pre-calibrated suspension settings, allowing rapid computation of target adjustments. Interpolation techniques may be used to compute intermediate suspension values when input parameters fall between LUT entries. Alternatively or additionally, the system may employ model-based control logic, such as a vehicle dynamics model or predictive control algorithm, to estimate the vehicle's response and compute suspension adjustments in real time. These approaches enable dynamic and responsive control of suspension parameters to enhance vehicle stability, traction, and handling during high-demand maneuvers.

For a specific example left turn or swerve here, operation 516 may include “increase right front spring force and increase right front jounce damping force” 518. When a softer or lower spring force and jounce damping force is used to prioritize comfort while riding in the vehicle, this allows the opposite (here right) side of the vehicle to roll lower on the outside of the turn (e.g., the right side for a left hand turn) while the inner side of the vehicle raises higher due to the centripetal force of the turn and the shifting of the weight of the vehicle to right and forward sides of the vehicle.

Adjusting the actuator at the active suspension at the front right tire during a fast left turn to increase the spring force at the right front tire makes the spring stiffer in order to manage the increased weight. Specifically, a stiffer spring resists compression where the spring force is proportional to the vertical displacement of the spring caused by compressive forces. As a result, the stiffer spring or greater spring force reduces body roll and helps keep the tire more firmly planted against the road surface. This results in a more direct transfer of load to the tire at that corner, improving grip, tire friction, and in turn, responsiveness. By better supporting the transferred weight with less chassis movement, the stiffer spring allows the suspension to maintain optimal tire contact, enhancing traction, handling agility, performance, and control during aggressive maneuvers such as the left swerve here. The exact amount of increase in spring force depends on the configuration of the active suspension as well as the other context factors of the vehicle, and is determined by experimentation. Thus rule-based algorithms and pre-determined look up tables may be used here as well for the exact values.

With regard to an active suspension command to increase the right front jounce damping force, the ‘damping’ rate at which the body or chassis of the vehicle moves toward the wheel is intentionally reduced by the active suspension commands at the front right wheel as the wheel and the body move vertically toward each other during the left entry turn and as the body rolls downward to the right. The damping force is proportional to that damping rate. Thus, the damping force is a force per vertical wheel velocity in all dampers. This also is referred to as reducing the rate the tire moves up into the vehicle. With the increased damping force and reduced damping rate, the roll of the body is slower (if not reducing roll itself) and more controlled to reduce the weight shift as well and in turn, the wheel stays in better contact with the road during the left turn or load build-up and therefore feels more planted and responsive.

Operation 516 also may include “increase left front rebound damping force” 520, and this refers to an active suspension command to decrease the rate that the left side inner front wheel will move vertically away from, or down from, the body and chassis. This also assists with reducing roll or at least reducing the rate of the roll, thereby resulting in an increased ‘flatness’ or reduced roll with reduced, or reduced rate of, weight shifts. Maintaining the vehicle in a flatter state increases the amount of downward force on all four tires, which in turn results in more tire friction and better handling, grip, traction, and/or control.

Operation 516 may include “increase right rear jounce damping force” 522, to provide an active suspension command to increase the handling as with the right front jounce damping force explained above.

Operation 516 may include “increase left rear rebound damping force” 524, and by providing an active suspension command and for the reasons mentioned above with the left front rebound damping force.

Operation 516 may include “increase roll stiffness” 526, and by the roll stiffness unit 334. By one form as mentioned above, the corner or wheel active suspensions 170, 172, 174, and 176 may provide sufficient roll stiffness control eliminating the need for the roll actuators and active suspensions 178 and 180. In this case, the four corner active suspensions 170, 172, 174, and 176 should have capacity in terms of force output, speed, and control resolution to manage roll forces in addition to handling ride comfort, bump absorption, and sufficient increased handling performance when needed. Otherwise, separate roll active suspensions 178 and 180 still may be present and operating.

In an active suspension system equipped with a dedicated roll actuator, roll stiffness can be dynamically adjusted in real time to manage vehicle body roll during cornering or evasive maneuvers. The roll actuator functions analogously to a passive sway bar by generating a counteracting torque that resists differential movement between the left and right suspension systems; however, unlike a passive sway bar with fixed torsional stiffness, the active system provides programmable and variable roll stiffness. When a lateral acceleration is detected, such as during a turn, the roll stiffness unit 334 may initiate a command to the roll actuator to apply a torque that opposes the angular displacement (0) between the left and right sides of the suspension. This torque can be defined similarly to a torsion spring using the relationship:

T=K_{act}·θ (1 )

where T is the applied torque, θ is the angular displacement, and K_{act} is an effective, controllable roll stiffness coefficient (e.g., in Nm/rad), analogous to a fixed K_{bar} value of a conventional sway bar.

By actively modulating K_{act} based on vehicle dynamics such as speed, steering input, and lateral acceleration, the system can reduce the roll gradient (e.g., degrees per lateral G) more precisely than a mechanical sway bar. This allows the vehicle to maintain a flatter posture during cornering, thereby increasing tire contact, improving lateral traction, and enhancing overall handling responsiveness. Unlike a passive sway bar, the roll actuator can be disengaged or softened during straight-line driving or rough terrain to preserve ride comfort, thus offering both dynamic roll resistance and adaptive ride quality in a unified system.

The process then may be repeated for a right exit turn for the left turn swerve when desired.

Regardless of the direction of the swerve, process 500 may include “setup for right turn” 528, and whether a right entry turn or a right exit turn. For this operation, the swerve avoidance unit 332 performs the same active suspension command generation at operations 530 to 538 numbered evenly, except the location of the wheel for the application of the active suspension commands is switched between left and right. Thus, these operations and commands for adjusting spring force (or stiffness), jounce, rebound, and roll stiffness do not need to be described again here.

When the steering direction unit 318 cannot determine which swerve direction to use, a steering wheel angle gradient unit 320 may perform the inquiry “which direction is steering wheel angle gradient?” 540, where the steering wheel angle gradient unit 320 may obtain steering wheel sensor data or parameters to determine which way (left or right) the steering wheel angle is tilted by the driver and that tends to indicate, the driver is starting to turn the wheel and in turn the vehicle in that direction. Once the direction is detected, active suspension commands are issued for a swerve in that direction.

When no direction is detected (the direction is zero degrees), or by some options no matter the direction or action being implemented to avoid the barrier or reduce contact with the barrier, process 500 may include “roll stiffness (sway) setup for turn” 542. This includes a number of operations to control (or reduce) roll stiffness as follows.

By one form, operation 542 may include “increase roll stiffness” 544, where roll stiffness is adjusted as explained above for operation 526 and 538. The roll stiffness is adjusted to provide best handling.

By one form, operation 542 may include “shift TLLTD using expected yaw vs. measured yaw” 546, and this may be performed by the under/over steer unit 336. Specifically, tire lateral load transfer distribution (TLLTD) is a function or proportion of the roll stiffness of the front axle versus the rear axle. Too much rear TLLTD and the rear tires lose grip before the front tires, and then the vehicle tends to want to oversteer such that the vehicle may fishtail or drift where the rear of the vehicle will not stay along the arc of the turn. In contrast, too much forward TLLTD results sin the front tires losing grip before the rear tires, and the vehicle will understeer where the front or nose of the vehicle will keep moving forward in a straighter line rather than along the arc of the turn. In this latter case, the vehicle does not turn enough and “pushes” wide, and when on a curve, the vehicle drifts toward the outside front corner even though the driver is trying to steer into the curve or arc.

Typically, a vehicle is designed with a slight understeer and slightly forward TLLTD which makes the front of the vehicle slip just a split second before the rear may slip. However, at some point, the slip or yaw of the vehicle is uncontrolled and potentially may cause unwanted contact with other objects. Thus, the under/over steer unit 336 may receive data of the expected yaw of the vehicle during a maneuver and the actual measured yaw both monitored in real-time. The under/over steer unit 336 then may compare the two yaws, and determine a difference between the expected yaw and the actual measured yaw. When the difference is larger than a threshold, the front and rear roll stiffnesses may be adjusted to regain better control of the yaw of the vehicle where the expected and measured yaw are the same or sufficiently similar. Thus, if the vehicle is in an oversteer and the measured yaw is greater than the expected yaw, the forward TLLTD can be increased to remove the difference. The opposite is true for an understeer.

By one form, operation 542 may include “increase damping” 548, and as mentioned above to reduce the damping rate. If a driver starts steering to one direction, or one of the directions is determined infeasible by the ADAS 312, then the process loops back to perform one of the swerves of operation 516 or 528.

While at least one example implementation has been presented in the foregoing detailed description, it should be appreciated that a vast number of variations exist. It should also be appreciated that the example implementations are not intended to limit the scope, applicability, or configuration of the disclosure in any way. Rather, the foregoing detailed description will provide those skilled in the art with a convenient road map for implementing the example implementations. It should be understood that various changes can be made in the function and arrangement of elements without departing from the scope of the disclosure as set forth in the appended claims and the legal equivalents thereof.

1. A method, comprising:
automatically monitoring, by at least one processor, a path in front of a vehicle to detect a barrier up ahead of the vehicle along the path and external to the vehicle, wherein the monitoring comprises determining a distance or time or both for the vehicle to reach the barrier, and wherein the vehicle has multiple wheels to propel the vehicle and active suspensions operably coupled to the wheels,
wherein each active suspension comprises an actuator arranged to selectively apply a force to affect motion between at least one of the wheels and a chassis of the vehicle, wherein the force is applied independently of passive mechanical reaction to the motion;
in response to detecting the barrier, determining, by at least one processor, at least one active suspension command to change a condition of at least one of the active suspensions and determined to at least one of: avoid contact between the vehicle and the barrier, reduce an amount of contact between the vehicle and the barrier, or change a location on the vehicle that will contact the barrier;
determining, by the at least one processor, that the contact is avoidable;
in response to determining the contact is avoidable, determining by the at least one processor, whether a current steering wheel angle gradient is to the left, the right, or zero,
in response to the steering wheel angle gradient indicating steering to the right, determining by the at least one processor, the active suspension commands to swerve the vehicle to the right of the barrier including increasing a left front spring force, increasing a left front jounce damping force, increasing a right front rebound damping force, increasing a left rear jounce damping force, increasing a right rear rebound damping force, and increasing a roll stiffness,
in response to the steering wheel angle gradient indicating steering to the left, determining, by the at least one processor, the active suspension commands to swerve the vehicle to the left of the barrier including increasing a right front spring force, increasing a right front jounce damping force, increasing a left front rebound damping force, increasing a right rear jounce damping force, increasing a left rear rebound damping force, and increasing a roll stiffness, and
in response to the steering wheel angle gradient being zero, determining, by the at least one processor, the active suspension commands including determining commands to increase roll stiffness to increase vehicle handling, shift a tire lateral load transfer distribution (TLLTD) to control yaw of the vehicle, and increase damping to control roll of the vehicle on at least one active suspension actuator to be applied before a subsequent evasive turn to avoid the barrier is executed in either the right or left directions; and
executing, by at least one processor, the active suspension command to change the condition of the at least one active suspension while the vehicle is traveling forward toward the barrier or avoiding the barrier.

2. The method of claim 1, comprising determining, by at least one processor, all of:
(a) whether or not an undesired contact event between the vehicle and the barrier is avoidable comprising determining whether the vehicle can (1) swerve to the left or right of the barrier and (2) stop directly behind the barrier without contacting the barrier, and
(b) whether or not the undesired contact event is unavoidable, and when unavoidable, changing a height of a front end of the vehicle to be closer to a height of the barrier.

3. The method of claim 1, wherein the active suspension command includes instructions to control the actuator to change the height of a front end of the vehicle to be closer to a height of the barrier, in response to a determination that the undesired contact event is unavoidable.

4. The method of claim 3, wherein the active suspension command directs at least one actuator of one of the active suspensions near a front of the vehicle to raise the front end of the vehicle.

5. The method of claim 3, comprising:
determining braking active suspension commands that control one or more of the actuators to enhance brake performance operations to slow or stop the vehicle or control a deceleration rate of the vehicle;
determining whether the braking active suspension commands counter-affect the active suspension command to change the height of the front end of the vehicle; and
refraining from executing the braking active suspension commands in response to determining that the braking active suspension commands counter-affect the active suspension command to change the height of the front end of the vehicle.

6. The method of claim 1, comprising determining whether or not a steering direction change will allow the vehicle to avoid the contact.

7. The method of claim 6, comprising automatically determining, by at least one processor, active suspension commands to execute a swerve to avoid the barrier comprising factoring at least one real-time factor of: vehicle speed, tire friction, and longitudinal acceleration of the vehicle.

8. (canceled)

9. (canceled)

10. (canceled)

11. (canceled)

12. A system, comprising:
a vehicle having a body on a chassis, wheels to propel the vehicle, and at least one active suspension operably coupling the chassis to the wheels, wherein each active suspension comprises an actuator arranged to selectively apply a force to affect motion between at least one of the wheels and the chassis of the vehicle, wherein the force is applied independently of passive mechanical reaction to the motion;
memory; and
processor circuitry forming one or more processors being communicatively coupled to the memory and the active suspension, the processor to operate by:
automatically monitoring a path in front of the vehicle to detect a barrier up ahead of the vehicle along the path and external to the vehicle, wherein the monitoring comprises determining a distance or time or both for the vehicle to reach the barrier,
in response to detecting the barrier, determining at least one active suspension command to change a condition of at least one of the active suspensions to at least one of: avoid contact between the vehicle and the barrier, reduce an amount of contact between the vehicle and the barrier, or change a location on the vehicle that will contact the barrier,
determining that the contact is avoidable;
in response to determining the contact is avoidable, determining whether a current steering wheel angle gradient is to the left, the right, or zero,
in response to the steering wheel angle gradient indicating steering to the right, determining the active suspension commands to swerve the vehicle to the right of the barrier including increasing a left front spring force, increasing a left front jounce damping force, increasing a right front rebound damping force, increasing a left rear jounce damping force, increasing a right rear rebound damping force, and increasing a roll stiffness,
in response to the steering wheel angle gradient indicating steering to the left, determining the active suspension commands to swerve the vehicle to the left of the barrier including increasing a right front spring force, increasing a right front jounce damping force, increasing a left front rebound damping force, increasing a right rear jounce damping force, increasing a left rear rebound damping force, and increasing a roll stiffness, and
in response to the steering wheel angle gradient being zero, determining the active suspension commands including determining commands to increase roll stiffness to increase vehicle handling, shift a tire lateral load transfer distribution (TLLTD) to control yaw of the vehicle, and increase damping to control roll of the vehicle on at least one active suspension actuator to be applied before a subsequent evasive turn to avoid the barrier is executed in either the right or left directions; and
executing the active suspension command to change the condition of the at least one active suspension while the vehicle is traveling forward toward the barrier or avoiding the barrier.

13. The system of claim 12, wherein the processor is arranged to operate by determining whether the contact between the vehicle and the barrier is unavoidable comprising comparing a closing speed the vehicle travels toward the barrier to a speed threshold and the distance between the vehicle and the barrier and a distance threshold.

14. The system of claim 13, wherein the speed and distance thresholds are a first set of thresholds, and the processor operates by determining whether the contact between the vehicle and the barrier is avoidable by stopping or turning the vehicle in time to avoid the barrier with a second set of the thresholds that are larger than the first set of thresholds.

15. A vehicle, comprising:
a body on a chassis, wheels to propel the vehicle, and at least one active suspension operably coupling the chassis to the wheels, and wherein each active suspension comprises an actuator arranged to selectively apply a force to affect motion between at least one of the wheels and the chassis of the vehicle, wherein the force is applied independently of passive mechanical reaction to the motion; and
one or more controllers comprising memory, and processor circuitry forming one or more processors communicatively coupled to the memory, wherein the processor is arranged to operate by:
automatically monitoring a path in front of the vehicle to detect a barrier up ahead of the vehicle along the path and external to the vehicle, wherein the monitoring comprises determining a distance or time or both for the vehicle to reach the barrier,
in response to detecting the barrier, determining at least one active suspension command to change a condition of at least one of the active suspensions to at least one of: avoid contact between the vehicle and the barrier, reduce an amount of contact between the vehicle and the barrier, or change a location on the vehicle that will contact the barrier,
determining that the contact is avoidable;
in response to determining the contact is avoidable, determining whether a current steering wheel angle gradient is to the left, the right, or zero,
in response to the steering wheel angle gradient indicating steering to the right, determining the active suspension commands to swerve the vehicle to the right of the barrier including increasing a left front spring force, increasing a left front jounce damping force, increasing a right front rebound damping force, increasing a left rear jounce damping force, increasing a right rear rebound damping force, and increasing a roll stiffness,
in response to the steering wheel angle gradient indicating steering to the left, determining the active suspension commands to swerve the vehicle to the left of the barrier including increasing a right front spring force, increasing a right front jounce damping force, increasing a left front rebound damping force, increasing a right rear jounce damping force, increasing a left rear rebound damping force, and increasing a roll stiffness, and
in response to the steering wheel angle gradient being zero, determining the active suspension commands including determining commands to increase roll stiffness to increase vehicle handling, shift a tire lateral load transfer distribution (TLLTD) to control yaw of the vehicle, and increase damping to control roll of the vehicle on at least one active suspension actuator to be applied before a subsequent evasive turn to avoid the barrier is executed in either the right or left directions, and
executing the active suspension command to change the condition of the at least one active suspension while the vehicle is traveling forward toward the barrier or avoiding the barrier.

16. The vehicle of claim 15, wherein the processor is arranged to determine whether the vehicle should turn to avoid the barrier or stay straight and stop to avoid the barrier.

17. The vehicle of claim 15, the processor is arranged to operate by factoring speed, tire friction, and longitudinal acceleration to determine a geometry of turns to be performed by the vehicle to avoid the barrier.

18. The vehicle of claim 15, wherein in response to determining the vehicle should turn or stop to avoid contact with the barrier while the vehicle is moving toward the barrier, the processor is arranged to operate by setting a torque on a roll stiffness actuator of the active suspension to reduce vehicle roll on the vehicle during a turn of the vehicle.

19. The vehicle of claim 15, wherein the processor is to operate by determining a difference between an expected yaw of the vehicle during a turn and a measured yaw of the vehicle during the turn, and modifying one or more roll shifting active suspension actuators to change a tire lateral load transfer distribution (TLLTD) to reduce the difference.

20. (canceled)

21. The method of claim 1, comprising determining whether open space having sufficient clearance for the vehicle exists to a left or right of the barrier; determining, based at least in part on the open space, whether a steering direction change will allow the vehicle to avoid the contact; and determining a direction to swerve around the barrier based at least in part on the open space.

22. The system of claim 12, wherein the at least one processor is arranged to operate by determining whether open space having sufficient clearance for the vehicle exists to a left or right of the barrier; determining, based at least in part on the open space, whether a steering direction change will allow the vehicle to avoid the contact; and determining a direction to swerve around the barrier based at least in part on the open space.

23. The vehicle of claim 15, wherein the processor is arranged to operate by determining whether open space having sufficient clearance for the vehicle exists to a left or right of the barrier; determining, based at least in part on the open space, whether a steering direction change will allow the vehicle to avoid the contact; and determining a direction to swerve around the barrier based at least in part on the open space.

24. The method of claim 1, comprising determining, by the at least one processor, a difference between an expected yaw of the vehicle during a turn and a measured yaw of the vehicle during the turn, and modifying one or more roll shifting active suspension actuators to change a tire lateral load transfer distribution (TLLTD) to reduce the difference.

25. The system of claim 12, wherein the processor is arranged to operate by determining a difference between an expected yaw of the vehicle during a turn and a measured yaw of the vehicle during the turn, and modifying one or more roll shifting active suspension actuators to change a tire lateral load transfer distribution (TLLTD) to reduce the difference.
